(19) United States
(12) Patent Application Publication
(10) Pub. No.: US 2006/0108985 A1
(43) Pub. Date: May 25, 2006

(54) Protection method of dynamically adjusting charging current

(75) Inventor: Jia-Shiung Kuo, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/991,504

(22) Filed: Nov. 19, 2004

(51) Int. Cl. H02J 7/00

(52) U.S. Cl. 320/141

(57) ABSTRACT

The present invention is to provide a protection method of dynamically adjusting a charging current for resolving problems of overcurrent-charging phenomenon and instability of supplying power for a system, in which a keyboard controller is applied to read the magnitude of charging current of a battery undergoing the charging process along with a control step performed on an output value according to the magnitude of charging current. As a result, the purpose of dynamically adjusting the charging current of the battery is accomplished for increasing the stability of supplying power for the system and preventing the battery from entering a protection mode.

### FIELD OF THE INVENTION

The present invention relates to a protection method of dynamically adjusting a charging current, more particularly to a protection method for resolving the problems of overcurrent-charging phenomenon and instability of supplying power for a system occurring in a charging process of a battery in the prior art.

### PRIOR ART

In general, the principal developing core of notebook computer framework nowadays is focused unceasingly on light, thin, short, and small weight and size besides the major developing goal of providing with all-in-one design unceasingly. As a result, all-in-one notebook computer is a general name of the portable computer nowadays. The tendency of notebook computer in 2003 and 2004 years is to provide with one-inch super-thin structure. It goes without saying that the market competition among notebook computers is intense. However, the arrangements of the battery layouts of the notebook computers, which are designed by various computer companies, are slightly different from one another. Most of these battery layouts use 18650-6 cylindrical lithium cells. The so-called 18650 stands for the size of the cylindrical lithium cell, wherein its external diameter is 18 mm and its height is 65 mm. The battery is mounted on the side surface at the rear end of the housing of every notebook computer.

There are two kinds of charging modes, i.e. the so-called fast charging mode and slow charging mode when these notebook computers charge the batteries mounted thereon. Nevertheless, no matter what kind of charging mode is applied, the charging current should be constant in theory. However, a keyboard controller (simply referred to as KBC) for providing a pulse width modulation (PWM) signal to decide the magnitude of the charging current of the battery is presently applied instead in order to reduce the production cost, wherein the keyboard controller is mainly applied to provide the required power for a hardware system on a motherboard. However, the pulse width modulation signal is a kind of pulsation signal, the signal, which is truly sent out, is not always very stable even if the keyboard controller provides a constant value for the interior pulse width modulation module. Furthermore, each battery has its own charging protection point, namely, when the charging current exceeds a value the charging process of the battery will be stopped.

In addition, when the battery undergoes the charging process, the exterior factor such as high temperature or low temperature and the aged product usually result in the instable output current of the charging process. In this manner, the battery will suffer from the overcurrent-charging phenomenon. Moreover, the instability of supplying power for the system is thus increased. In the mean while, it cannot prevent the battery from entering the protection mode. The protection mode means that every battery has a specified charging current. If the charging current is larger than a predetermined value, the battery will stop the charging process, namely, it is locked.

Accordingly, it may say that users suffer from a lot of perplexity and inconvenience. It goes without saying that much valuable time is wasted and requirements of the times are not satisfied. As a result, the manufactures make efforts to develop and invent a method of avoiding the overcurrent-charging phenomenon and thereby providing more perfect and powerful functions for satisfying users' requirements.

### SUMMARY OF THE INVENTION

In view of aforementioned detailed description of the prior art, it is apparent that the overcurrent-charging phenomenon is usually formed on a battery when the present notebook computer undergoes the charging process. Because of the exterior factors or the occasional instability of the signal, which is sent out for supplying power for the interior hardware, the output current of the charging process is instable. At the same time, drawbacks, for example, the increased instability of supplying power for the system and so forth, are generated. Accordingly, the inventor has been made sustained researches and experiments to eventually develop a protection method of dynamically adjusting a charging current of the present invention in accordance with the inventor's accumulated experience and skill in the art and the practical requirements of users and markets for further controlling the magnitude of the charging current of the battery.

One aspect of the present invention is to provide a protection method of dynamically adjusting a charging current. This method is to resolve the overcurrent-charging phenomenon and the increased instability of supplying power for the system, which occur in the charging process of the battery of the prior art. According to the disclosed method of the present invention, a keyboard controller is applied to read the magnitude of the charging current when a battery undergoes the charging process. Next, a control step is further performed on an output value according to the magnitude of the charging current. As a result, the purpose of dynamically adjusting the charging current of the battery is accomplished for increasing the stability of supplying power for the system and preventing the battery from entering a protection mode.

Another aspect of the present invention is to provide a protection method of dynamically adjusting a charging current, wherein when the keyboard controller checks and determines that the present charging current value of the battery terminal is larger than the predetermined value of the battery itself, the keyboard controller will immediately reduce a PWM signal to control and adjust the output value of the charging current for the battery terminal; when the keyboard controller checks and determines that the present charging current value of the battery terminal is smaller than the predetermined value of the battery, the keyboard controller will immediately increase the PWM signal to control and adjust the output value of the charging current for the battery terminal; when the keyboard controller checks and determines that the present charging current value of the battery terminal is equal to the predetermined value of the battery, the keyboard controller will persistently output the charging current with the present value for the battery terminal.

The above and other objects, features and advantages of the present invention will become apparent from the following detailed description taken with the accompanying drawings.

### BRIEF DESCRIPTION OF THE DRAWINGS

FIG. 1 is a schematic view showing a process diagram of a preferred embodiment of the present invention.

### DETAILED DESCRIPTION OF THE PREFERRED EMBODIMENT

The present invention relates to a protection method of dynamically adjusting a charging current. This method is to firstly read a charging current value of the battery terminal by using a keyboard controller (simply referred to as KBC), which provides the required power for the hardware system, on an electronic device during the charging procedure of the battery on the electronic device. Next, the keyboard controller sends a detection command to the battery terminal at any time to read the present magnitude of the charging current of the battery terminal. After the present charging status of the battery terminal is checked, a PWM signal is increased or reduced according to the present status value of the charging current so as to control and adjust the output value of the charging current for the battery terminal at any time. As a result, the purposes of protection and dynamically adjusting the charging current of the battery are accomplished for effectively increasing the stability of supplying power for the system and preventing the battery from entering a protection mode. The protection mode means that every battery has a specified charging current. If the value of the charging current is larger than a predetermined value, the battery will stop the charging process and be locked. At the same time, the stability of supplying power for the system is increased.

In the preferred embodiment of the present invention, the electronic device is a notebook computer. The PWM signal is applied to control the magnitude of the output current for deciding the magnitude of the charging current.

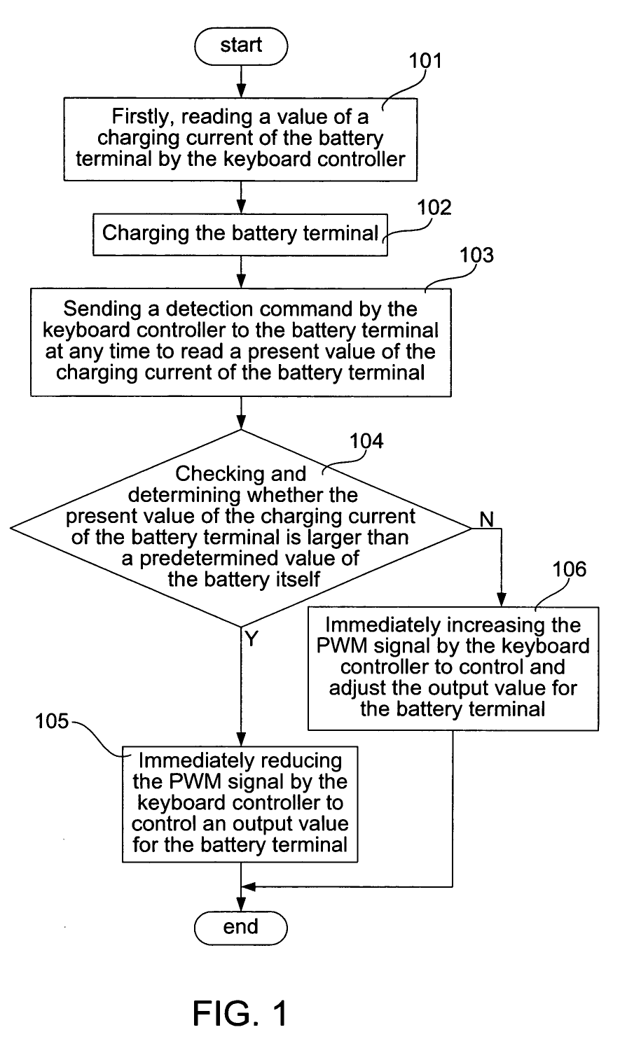

The method of accomplishing the present invention is exhaustively described in the following description, together with a preferred embodiment. Referring to FIG. 1, when the battery on the electronic device undergoes the charging process, the keyboard controller on the electronic device will perform the following steps of:

(step 101) firstly, reading a value of a charging current of the battery terminal by the keyboard controller to obtain a current value that must be provided for the battery terminal;

(step 102) next, charging the battery terminal;

(step 103) sending a detection command by the keyboard controller to the battery terminal at any time to read a present value of the charging current of the battery terminal;

(step 104) checking and determining whether the present value of the charging current of the battery terminal is larger than a predetermined value of the battery itself; if positive, the next step 105 is then performed; if negative, the step 106 is then performed;

(step 105) immediately reducing the PWM signal by the keyboard controller to control and adjust an output value for the battery terminal; next, this processing procedure is terminated;

(step 106) immediately increasing the PWM signal by the keyboard controller to control and adjust the output value for the battery terminal; next, this processing procedure is terminated;

In addition, in the above step 104, if the keyboard controller checks and determines that the present value of the charging current of the battery terminal is equal to the predetermined value of the battery itself, the charging current with the present value is persistently outputted to the battery terminal. As a result, the purposes of protection and dynamically adjusting the charging current of the battery are accomplished for effectively increasing the stability of supplying power for the system and preventing the battery from entering a protection mode.

While the invention has been described by means of specific embodiments, numerous modifications and variations could be made thereto by those skilled in the art without departing from the scope and spirit of the invention set forth in the claims.

What the invention claimed is:

1. A protection method of dynamically adjusting a charging current, in which when a battery on an electronic device undergoes a charging process a keyboard controller on the electronic device will perform the following steps of:
reading a value of a charging current of the battery terminal;
next, sending a detection command by the keyboard controller to the battery terminal at any time to read a present value of the charging current of the battery terminal; and
checking a present status of the charging current of the battery terminal and dynamically increasing or reducing a pulse width modulation (PWM) signal according to the present status value of the charging current so as to control and adjust the output value of the charging current for the battery terminal.

2. The protection method of dynamically adjusting the charging current of claim 1, wherein when the battery on the electronic device undergoes the charging process the keyboard controller on the electronic device will perform the following steps of:
firstly, reading the value of the charging current of the battery terminal by the keyboard controller to obtain the current value that must be provided for the battery terminal;
next, charging the battery terminal;
sending the detection command by the keyboard controller to the battery terminal at any time to read the present value of the charging current of the battery terminal;
checking and determining whether the present value of the charging current of the battery terminal is larger than a predetermined value of the battery itself so as to control and adjust the output value of the charging current for the battery terminal; and next, the charging process is terminated.

3. The protection method of dynamically adjusting the charging current of claim 2, wherein if the keyboard controller checks and determines that the present value of the charging current of the battery terminal is smaller than the predetermined value of the battery, the keyboard controller will immediately increase the PWM signal to control and adjust the output value of the charging current for the battery terminal; and the processing procedure is then terminated.

4. The protection method of dynamically adjusting the charging current of claim 2, wherein if the keyboard controller checks and determines that the present value of the charging current of the battery terminal is equal to the predetermined value of the battery, the charging current with the present value is persistently outputted to the battery terminal.

5. The protection method of dynamically adjusting the charging current of claim 1, wherein the electronic device is a notebook computer and the keyboard controller on the electronic device is applied to provide the required power for a hardware system, and the PWM signal is applied to control the value of the output current for deciding the value of the charging current.
